(19) United States
(12) Patent Application Publication
(10) Pub. No.: US 2012/0291081 A1
(43) Pub. Date: Nov. 15, 2012

(54) TELEVISION WITH IMPROVED GRAPHICAL USER INTERFACE

(76) Inventors: Maria Cabrera, Los Angeles, CA (US); Adrian Rosa, Kissimmee, FL (US)

(21) Appl. No.: 13/106,669

(22) Filed: May 12, 2011

(51) Int. Cl. H04N 21/426; H04N 5/445

(52) U.S. Cl. 725/110; 348/563; 348/E05.099

(57) ABSTRACT

A television set. At least one peripheral electronic device is connected to the television set. The television set includes a processor that is programmed to display images on the television set. The processor is further programmed to connect the peripheral electronic device such that an image is displayed to the viewer so that the viewer can select the peripheral electronic device immediately after turning on the television set. In a preferred embodiment the peripheral electronic device is a Roku® Internet video streaming receiver box.

The present invention relates to television sets, and in particular, to television sets that are connected to the Internet.

### BACKGROUND OF THE INVENTION

### Televisions with Graphical User Interface (GUI)

In modern society it has become very popular to watch television. Furthermore, with the advent of the Internet it has also become popular to combine the television set with other electronic peripheral devices, such as Playstation® game console, an X-box® game console, or an Internet video streaming receiver box. An example of an Internet video streaming receiver box currently available is the Roku Internet video streaming receiver box made by the Roku Corporation with offices in Saratoga, California. ROKU is a federally registered trademark of the Roku Corporation and refers generally to Internet streaming receiver boxes.

FIG. 1 shows prior art television set 10 after it has been turned on. In the prior art television sets will begin broadcasting the last channel to which the television was last set. For example, in FIG. 1, the viewer tends to normally watch television by virtue of a digital cable signal that is transmitted from a cable signal provider to the television set 10 via cable box 20. The cable box is transmitted to set 10 via a component 1 input jack on the side of the television. Also connected to set 10 is internet video streaming receiver box 30. Box 30 is connected to the Internet and is also connected to the set via a component 2 jack on the side of television set 10.

After turning on set 1, the screen will appear as shown in FIG. 1. In order for the viewer to change the set to a different input, he will have to press “input” button on his remote control device. At the bottom of the screen the viewer will then see images similar to that shown in FIG. 2. The viewer selects button 2 for the component 2 input to view images transmitted via internet video streaming receiver box 30. To change back to viewing images received via cable box 20, the viewer once again has to press “input” on his remote and then select button 1 for the component 1 input. Although this prior art method is effective, it is also cumbersome and awkward.

What is needed is a better method for selecting input devices to a television set.

### SUMMARY OF THE INVENTION

The present invention provides a television set. At least one peripheral electronic device is connected to the television set. The television set includes a processor that is programmed to display images on the television set. The processor is further programmed to connect the peripheral electronic device such that an image is displayed to the viewer so that the viewer can select the peripheral electronic device immediately after turning on the television set. In a preferred embodiment the peripheral electronic device is a Roku® Internet video streaming receiver box.

### BRIEF DESCRIPTION OF THE DRAWINGS

FIGS. 1-2 show a prior art method for selecting a peripheral electronic device.

FIGS. 3-3B show preferred embodiments of the present invention.

FIGS. 4-5 show preferred main screens.

FIGS. 6-9 show preferred picture adjustments.

FIGS. 10-13 show preferred sound adjustments.

FIGS. 14-16 show preferred channel adjustments.

FIG. 17 shows preferred parental controls.

FIGS. 18-20 show preferred set-up adjustments.

FIG. 21 shows other preferred adjustments.

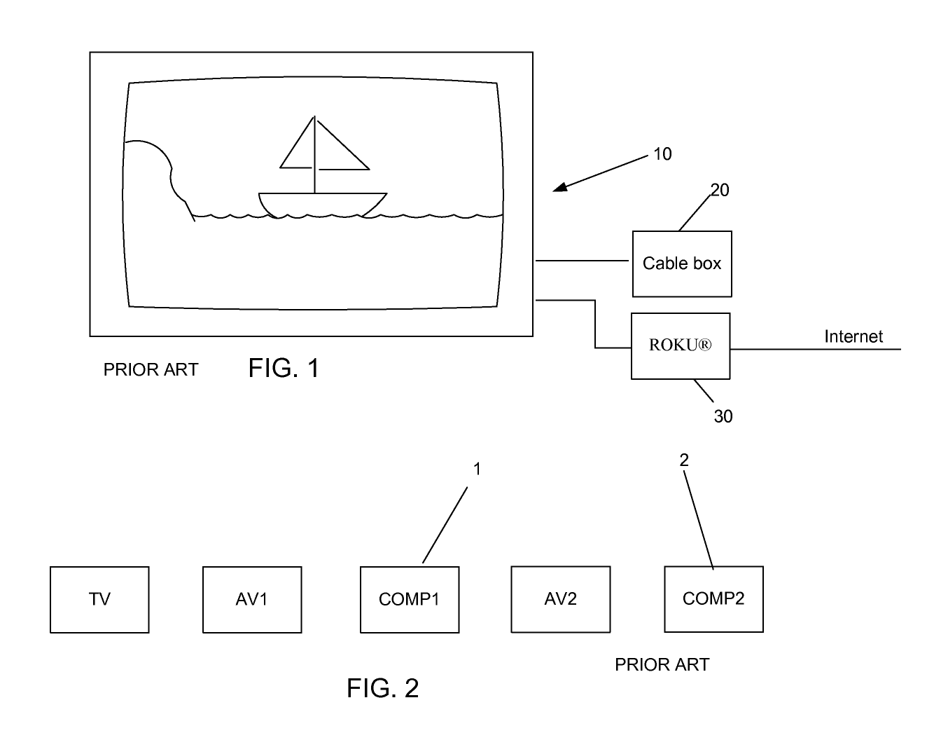

### DETAILED DESCRIPTION OF THE PREFERRED EMBODIMENTS

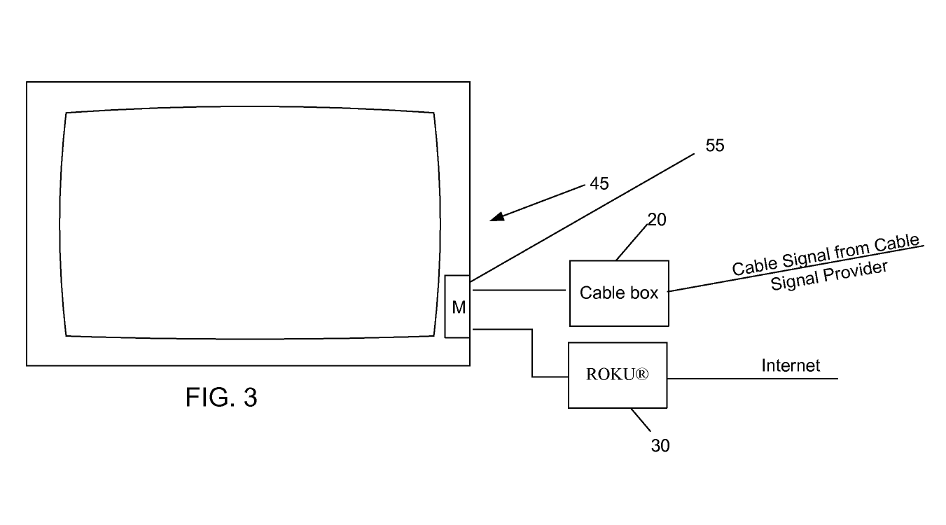

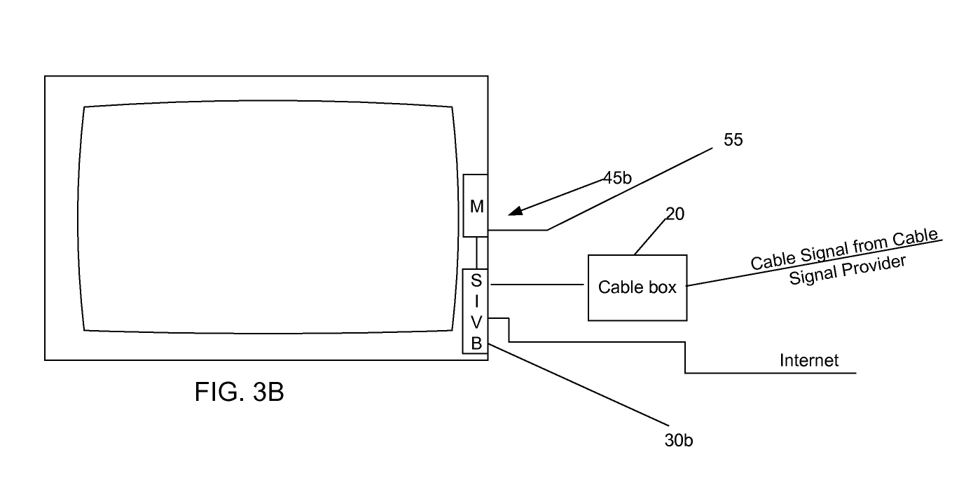

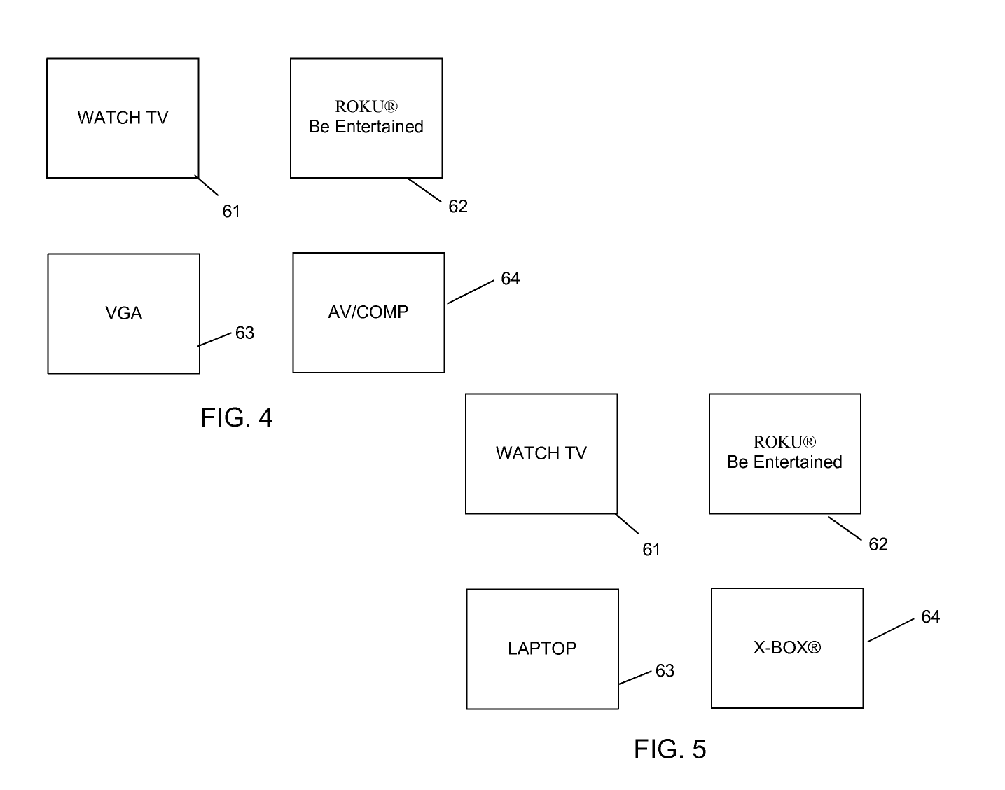

FIG. 3 shows a preferred embodiment of the present invention. Television set 45 includes microprocessor 55. Microprocessor 55 has been programmed to eliminate the need for the viewer to press an “input” button on his remote to observe a screen similar to that shown in FIG. 2. In the preferred embodiment shown in FIG. 3, after the user turns set 45 on, he will immediately observe a screen similar to that shown in FIG. 4. To watch TV the user selects button 61, to watch streaming Internet video via streaming Internet video box 30 the user selects button 62, to watch a device connected via VGA the user selects button 62, to watch a device connected via AV/COMP the user selects button 63. FIG. 5 is similar to FIG. 4 except that it shows that a laptop is connected via VGA and that the AV/COMP device is an X-Box® game console.

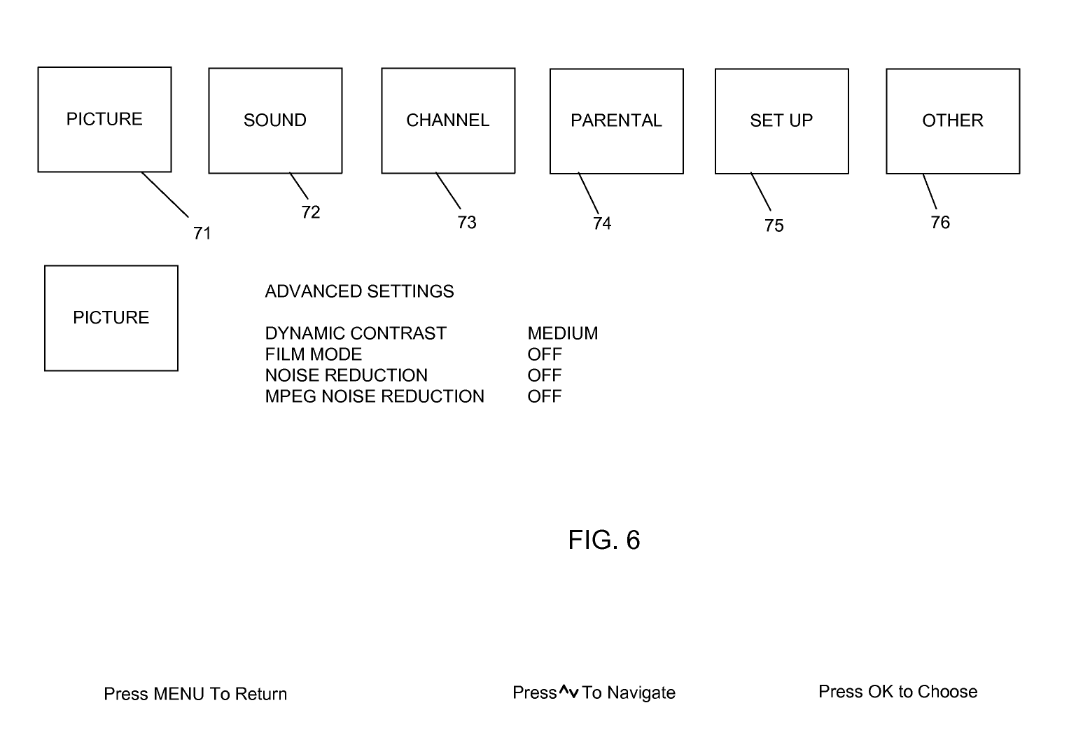

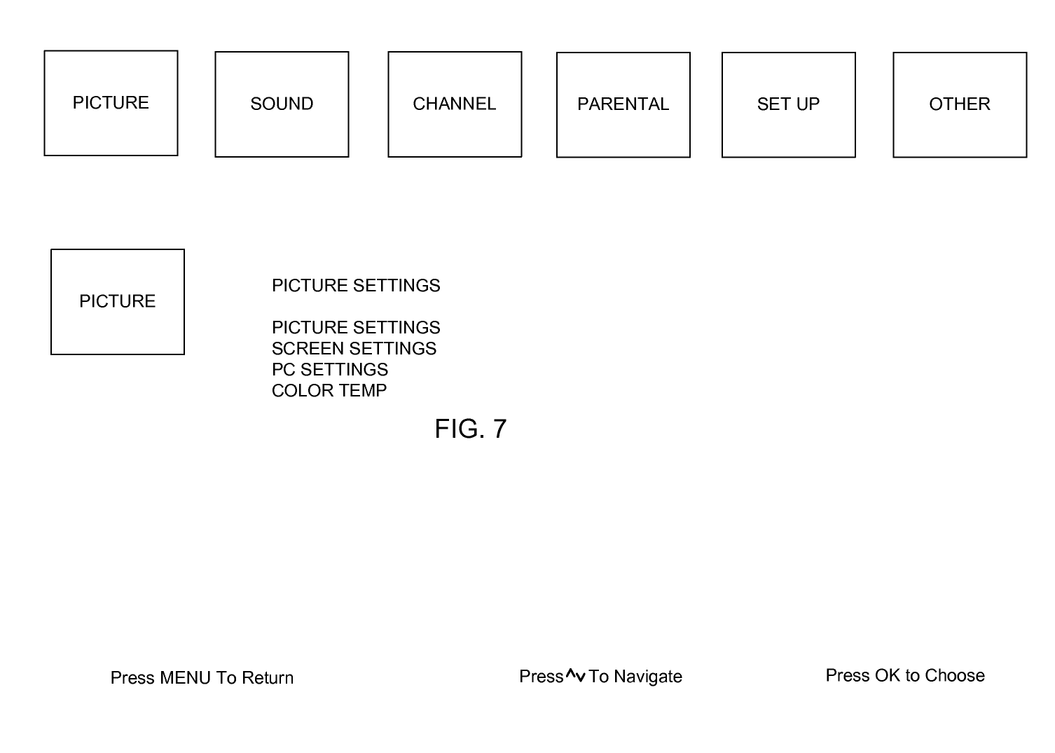

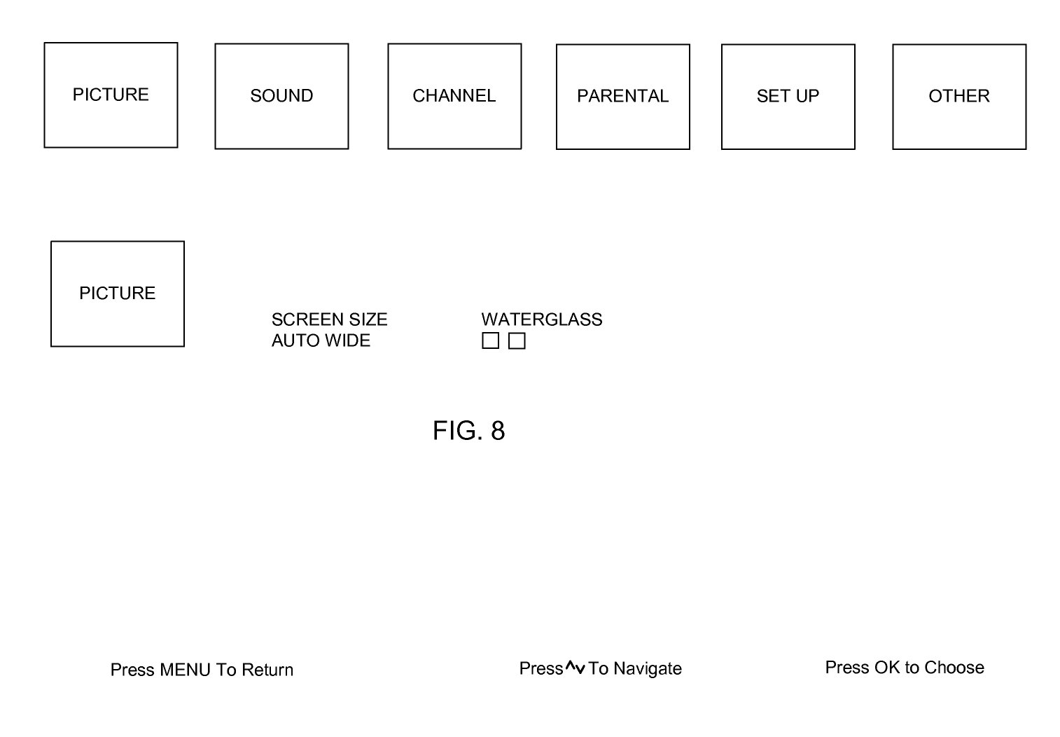

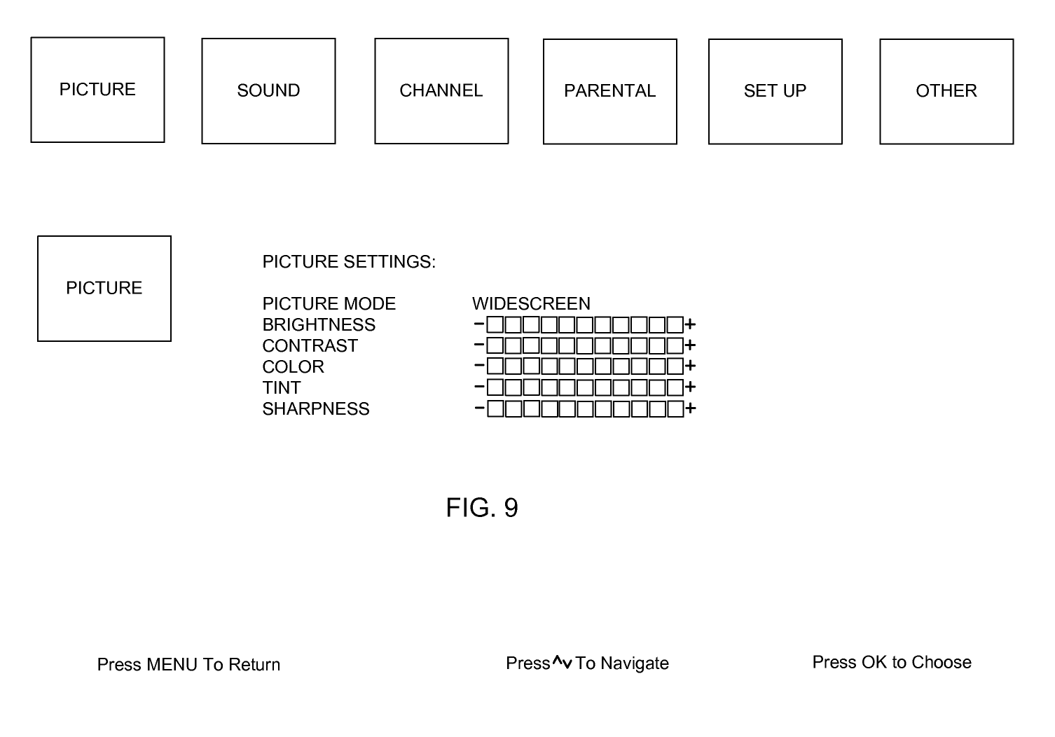

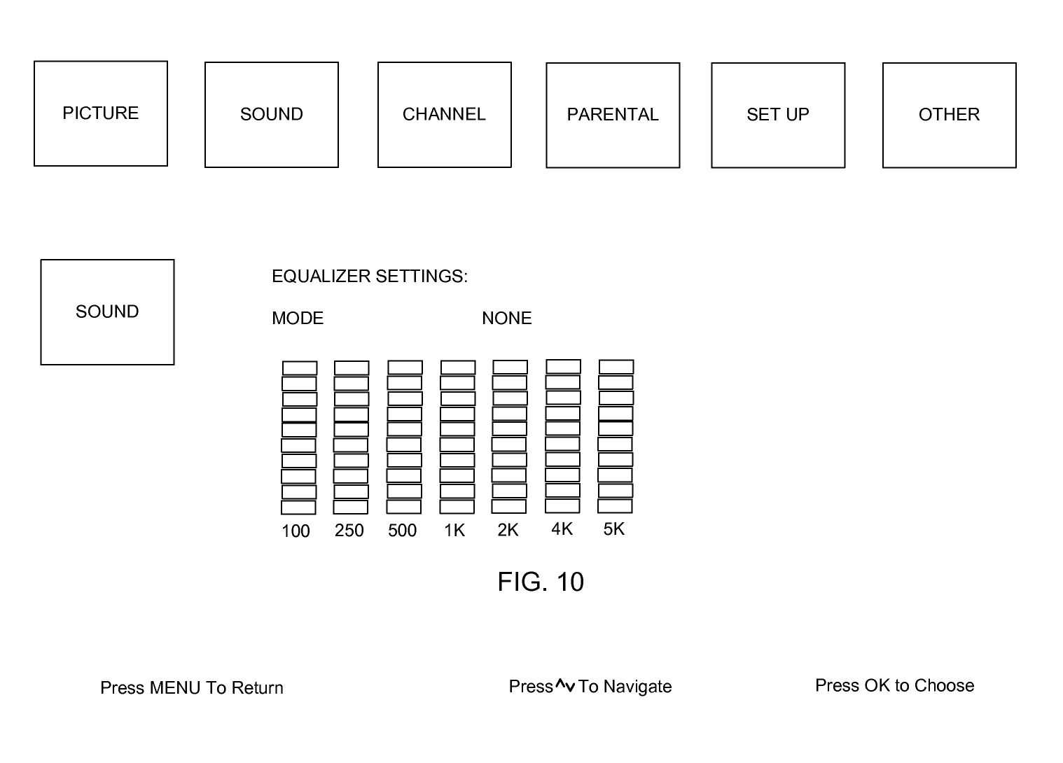

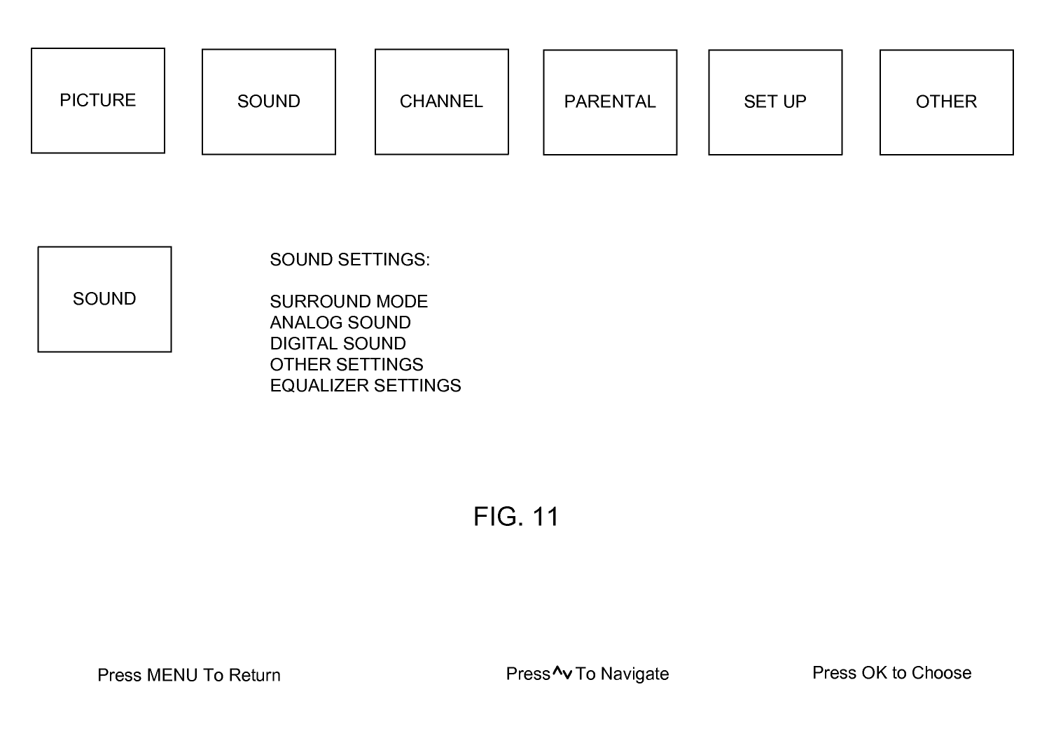

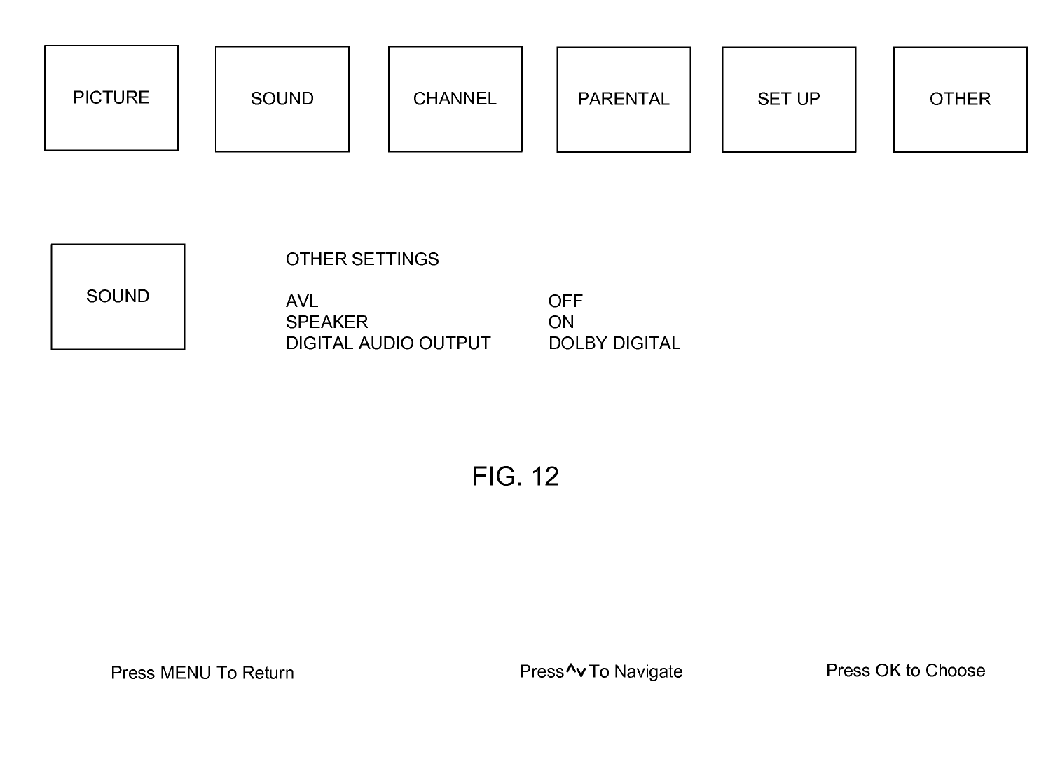

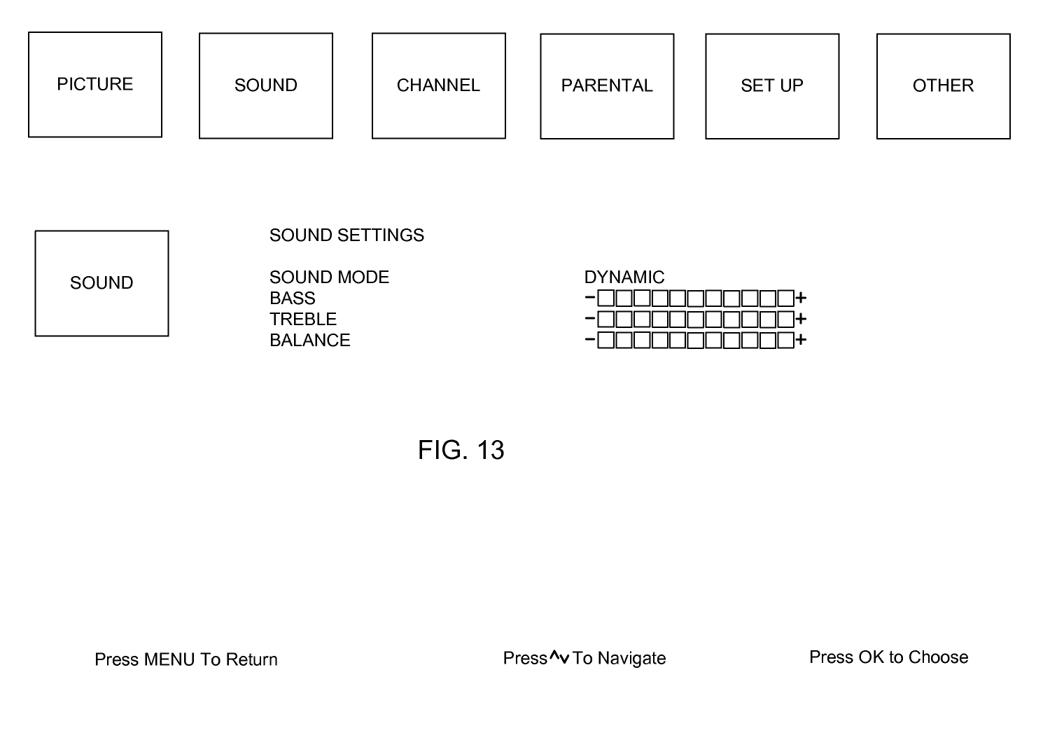

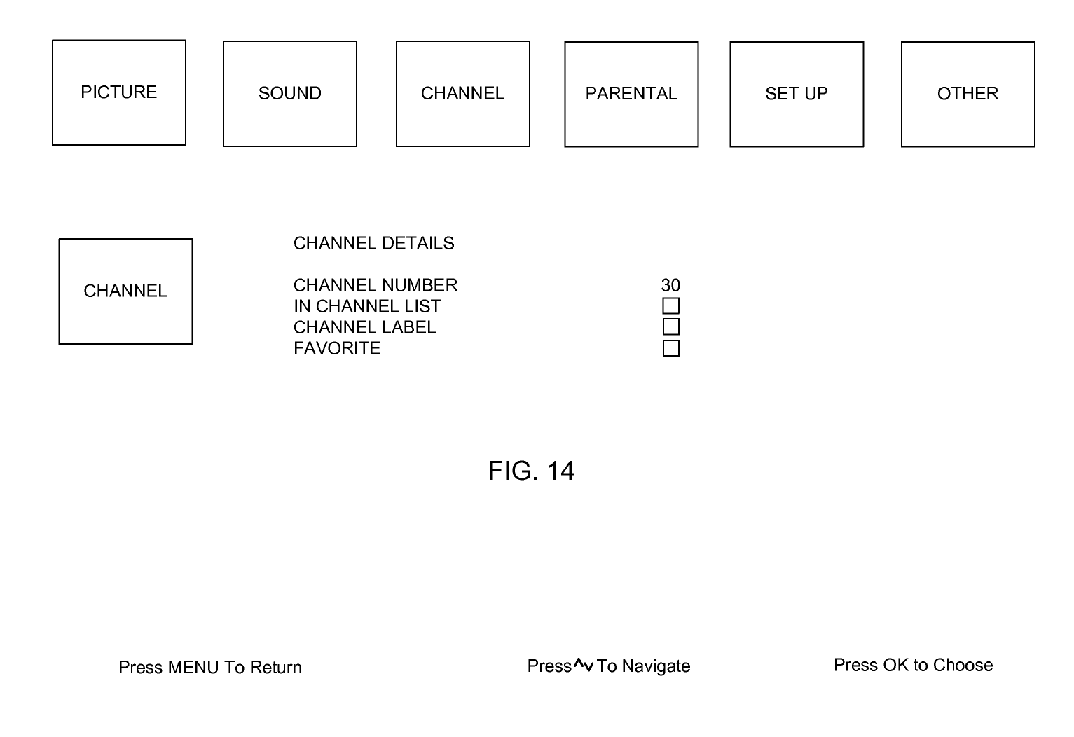

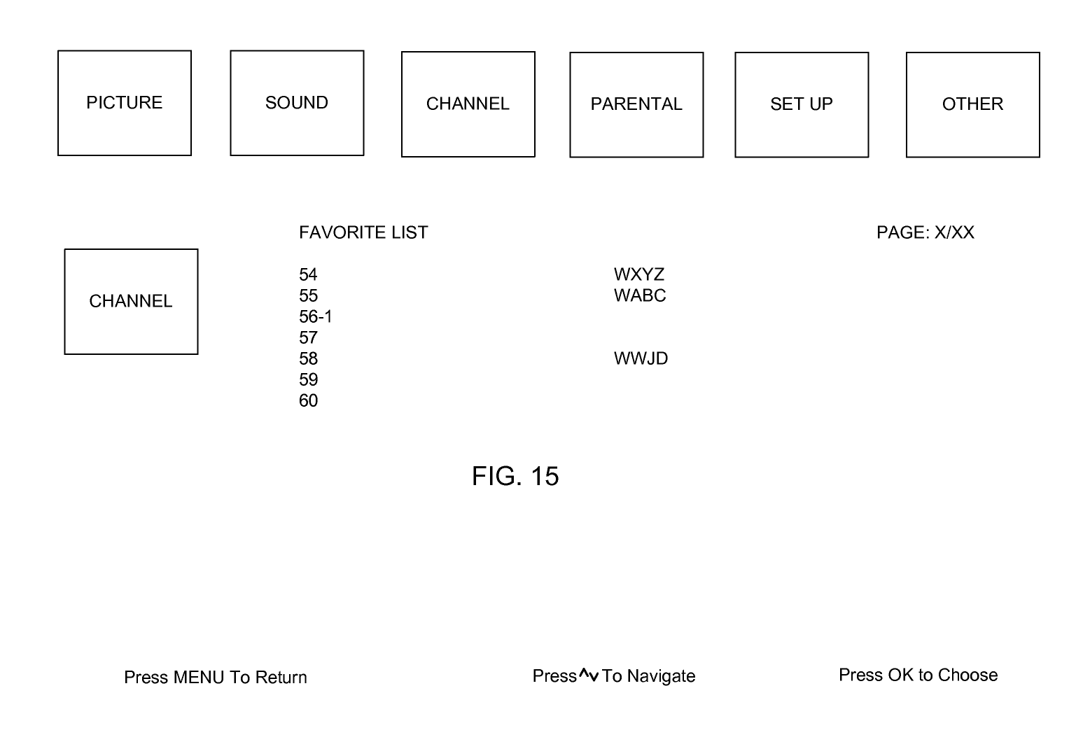

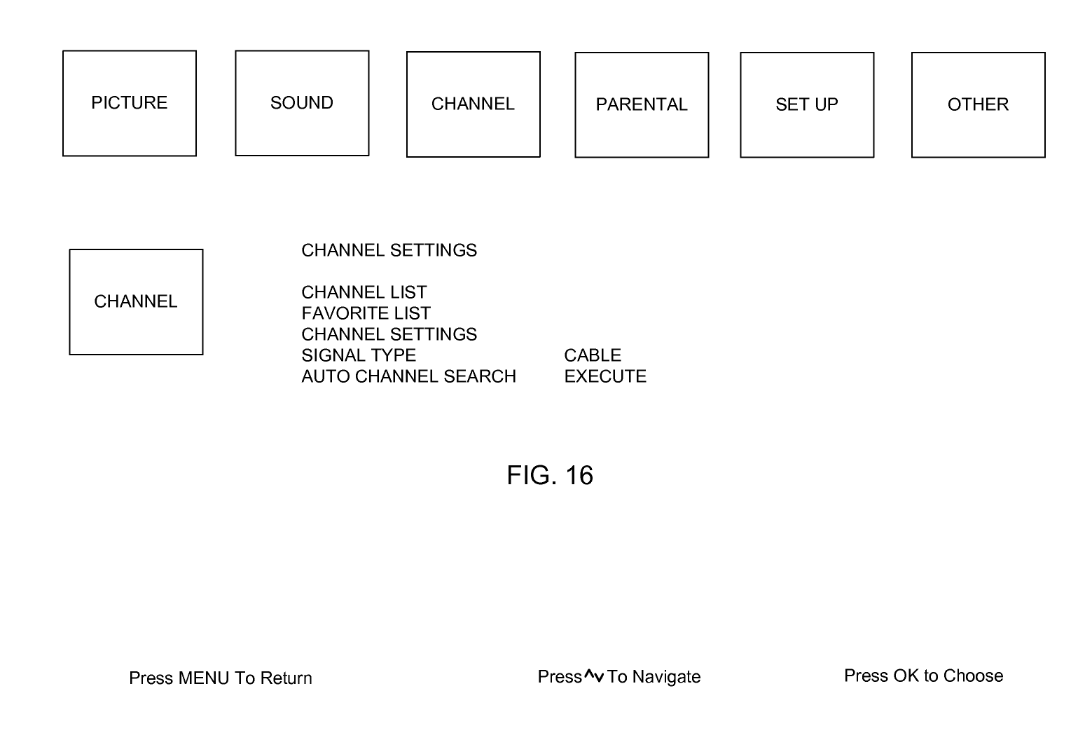

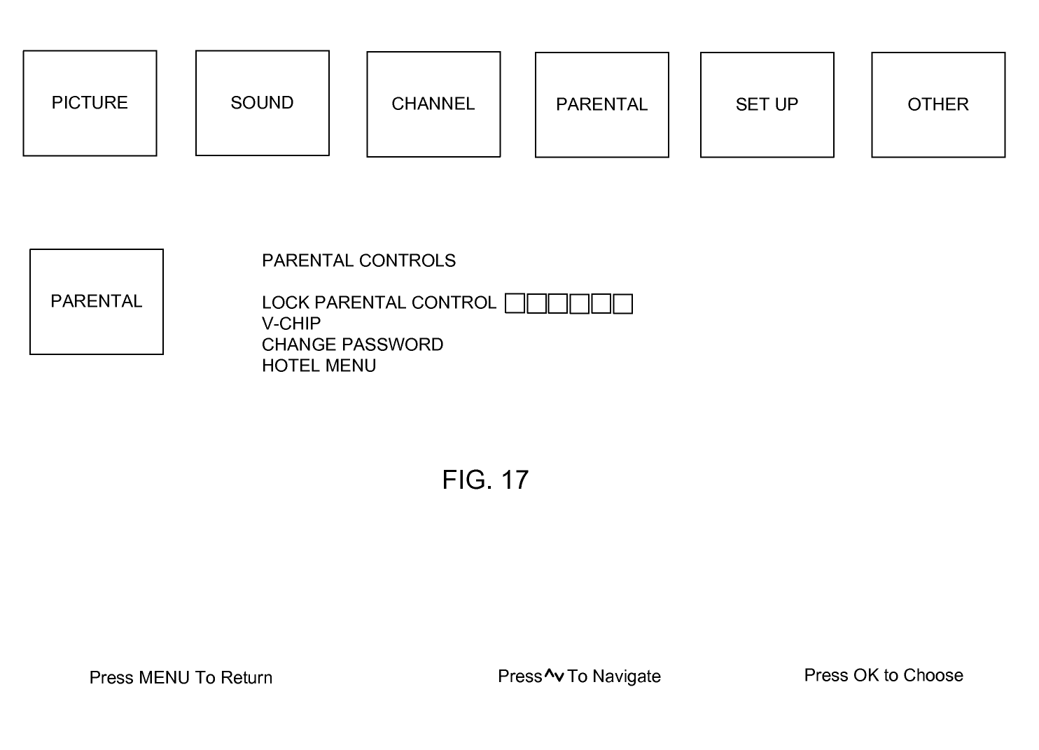

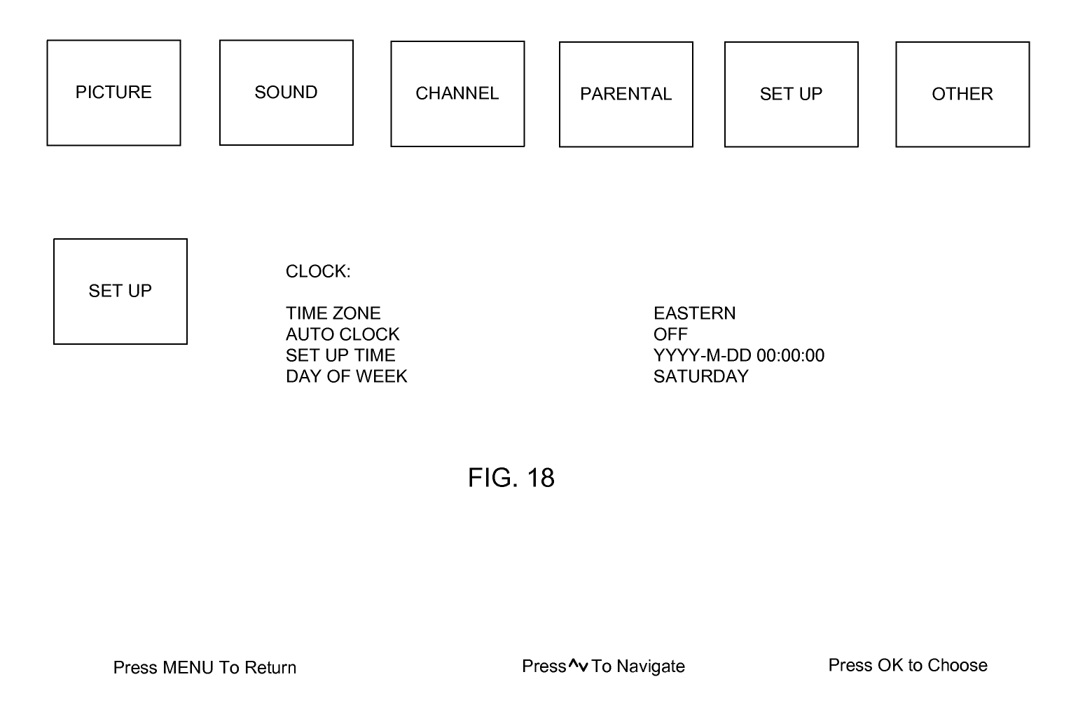

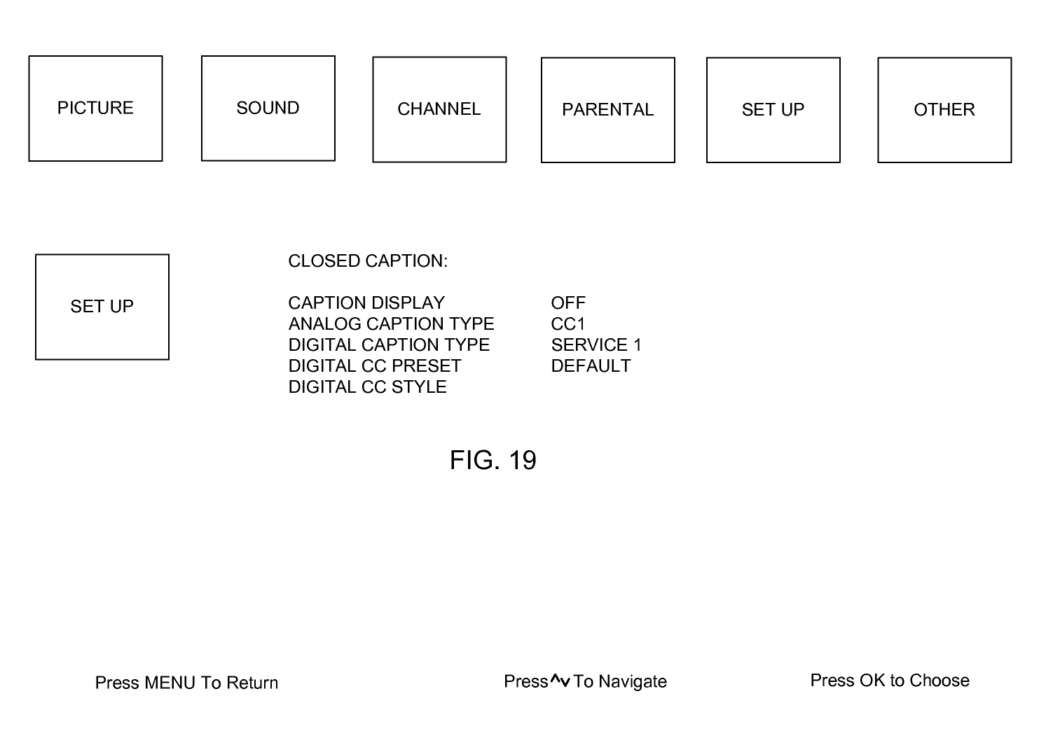

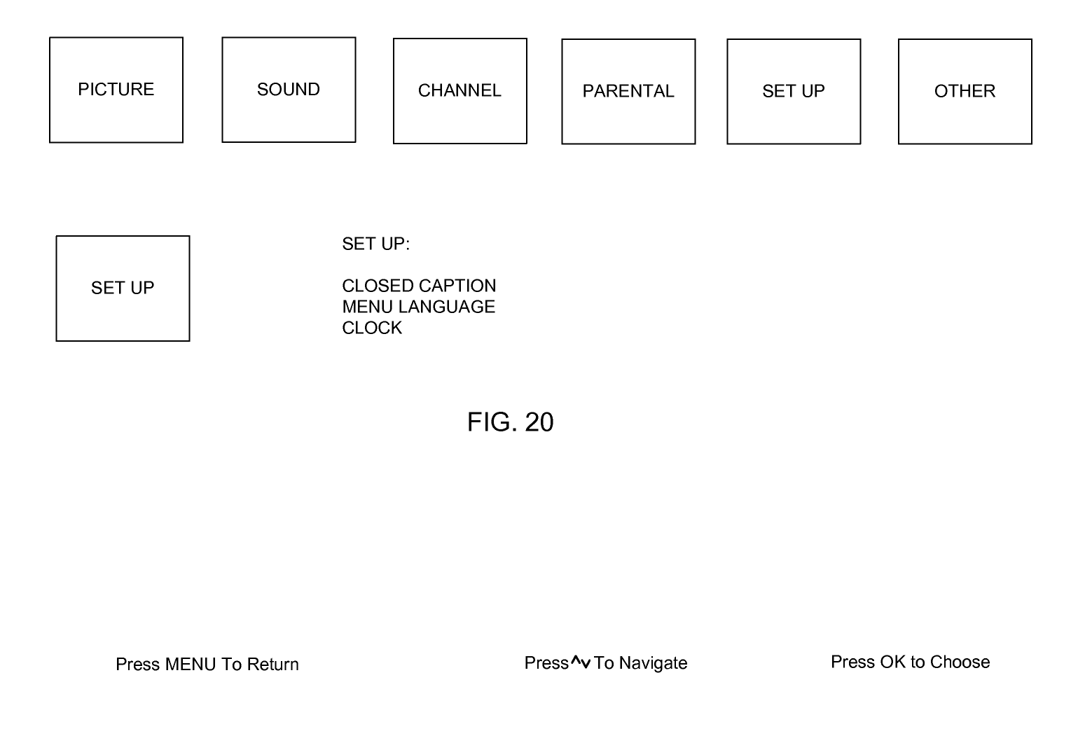

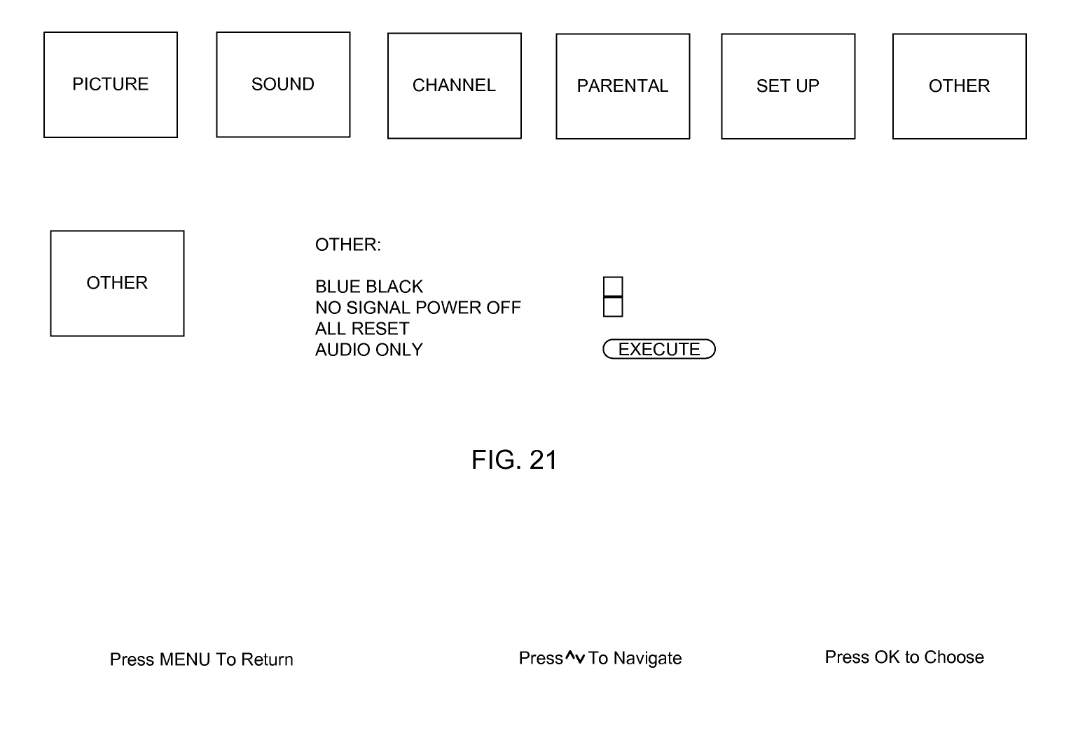

To adjust the features of television set 45, the view presses “menu” on his remote control device. He will then observe a screen similar to that shown in FIG. 6. The view then has the option of adjusting the picture by selecting button 71, the sound by selecting button 72, adjust channel features by selecting button 73 , set parental controls by selecting button 74, adjust set up features by selecting button 75, or make other adjustments by selecting button 76. For example, FIGS. 6-9 show preferred picture adjustments. FIGS. 10-13 show preferred sound adjustments. FIGS. 14-16 show preferred channel adjustments. FIG. 17 shows preferred parental controls. FIGS. 18-20 show preferred set-up adjustments. FIG. 21 shows other preferred adjustments.

### Other Preferred Embodiments

FIG. 3B shows another preferred embodiment of the present invention. Television set 45b is similar to the television set 45 shown in FIG. 3. However, streaming Internet video box 30b has now been imbedded into television set 45b. This allows for a more efficient and easier to use television set with greater space savings.

It should be understood also that the present invention can be utilized with a variety of television set configurations, including all forms of Smart TVs, LED TVs, LCD TVs, and Plasma TVs.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A television set, comprising
A. a television screen,
B. at least one peripheral electronic device connected to said television set, and
C. a processor programmed to cause images to be displayed on said television screen, and said processor further being programmed to connect said at least one peripheral electronic device such that an image is displayed on said television screen so that a viewer can select said at least one peripheral electronic device immediately after turning on said television set.

2. The television set as in claim 1, wherein said at least one peripheral electronic device is an internally mounted Internet video streaming receiver box connected to said processor and providing information from the Internet to said processor.

3. The television set as in claim 1, wherein said at least one peripheral electronic device is a Internet video streaming receiver box connected to said processor and providing information from the Internet to said processor.

4. The television set as in claim 1 wherein said at least one peripheral electronic device is a Roku® Internet video streaming receiver box.

5. The television set as in claim 1, wherein said television set is LCD television set.

6. The television set as in claim 1, wherein said television set is a LED television set.

7. The television set as in claim 1, wherein said television set is a Plasma television set.

8. The television set as in claim 1, wherein said television set is a smart television set.
